(19) United States
(12) Patent Application Publication
(10) Pub. No.: US 2006/0028815 A1
(43) Pub. Date: Feb. 9, 2006

(54) Light assembly comprising integrated passive and active illumination sources

(75) Inventor: Gary I. Robin, Niles, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Triplex Manufacturing Company, Chicago, IL (US)

(21) Appl. No.: 10/911,081

(22) Filed: Aug. 3, 2004

(51) Int. Cl. F21V 9/00

(52) U.S. Cl. 362/231

(57) ABSTRACT

A light assembly, suitable for use on a motorized vehicle, provides both active and passive illumination via optical elements carried by a single platform/structure. Active illumination and passive illumination elements provide illumination from separate and distinct, yet intermingled, surface areas of the single platform/structure of an assembly. The active illumination elements are interspersed/interleaved with the passive illumination source(s). Furthermore, the passive illumination is provided by “retro reflective” material that reflects light back at its source within a wide range of angles of incidence. In an embodiment of the invention, the active illumination is carried out by light emitting diodes mounted upon a platform of the light assembly that also holds the retro reflective passive illumination source.

### TECHNICAL FIELD

The present invention generally relates to the field of electronic lamp assemblies, and more particularly assemblies that incorporate light emitting diodes (LEDs). Such assemblies have been incorporated into taillights, backup lights and turn signals on motor vehicles.

### BACKGROUND

Federal and international laws/regulations exist that are directed to ensuring the conspicuity of motor vehicles. Such guidelines address both active illumination and retro reflectivity (wherein light is re-directed back towards its source from a variety of coincident angles) that are mandated for motorized vehicles. Previously, such requirements have been primarily met by signal/light assemblies wherein an incandescent bulb is housed within a chamber having a relatively opaque retro-reflective external cover. More recently, incandescent bulbs have been replaced by arrays of colored LEDs. Using LEDs in place of an incandescent light bulb generally results in lower power consumption, faster signal response (turn on/off) times, and lower maintenance costs (since the expected lifespan of the LEDs within a signal/light assembly substantially exceeds that of a motorized vehicle).

There are numerous examples of using LED arrays in place of an incandescent light bulb in a motor vehicle signal/light assembly. Typical LEDs are generally much smaller than incandescent light bulbs and emit substantially less light. Therefore, to provide sufficient light intensity, a cluster of LEDs typically replaces a single light bulb when incorporated into a motor vehicle signal/light assembly.

Known LED assembly designs include features that are intended to enhance the visibility of LED-based signals/lights. A number of mirror surface-based reflector designs for directing/dispersing the light emitted by LEDs have been proposed to make more efficient use of smaller quantities of LEDs within a signal/light. For example, U.S. Pat. No. 6,113,247 discloses a vehicle light assembly comprising a set of LEDs wherein each LED is placed within a concave reflector/mirror structure that redirects radiant light from the LEDs in a desired direction. The concave mini-reflectors direct light from an LED away from a surface upon which a light assembly containing the mini-reflectors is mounted thereby enhancing the visibility of the light assembly.

A vehicle light assembly comprising LEDs is disclosed in US Application Pub. U.S. 2003/0142505 wherein a multi-faceted/ridged reflector surface disperses light emitted by a relatively small number of LEDs arranged along a circumference of the vehicle light assembly. The multi-faceted/ridged mirror-like reflector surface performs the primary function of dispersing and re-directing the light emitted by the LEDs away from the light assembly. A clear lens is placed over the LEDs to protect the electronic components from moisture and dirt. The mirror-like reflector also functions to reflect incoming visible light, un-attenuated by the clear lens (or any other colorized/attenuating filter), back at a source of external light (e.g., a trailing vehicle). Such reflection of un-attenuated incoming light, a virtual necessity of the disclosed design to ensure sufficient visibility of light emitted by the minimal number of LEDs, enhances the visibility of the vehicle to others. However, such enhanced visibility of reflected light from the headlamps of a trailing vehicle potentially prevents detecting active illumination when the light assembly is illuminated by an external light source (e.g., the headlights of a trailing vehicle). As a consequence, the effectiveness of the light assembly disclosed in Published U.S. 2003/014505 to provide detectible active illumination (in response to a user applying breaks) is reduced at night when the headlights of a trailing vehicle shine upon the reflective surface of the disclosed vehicle light assembly.

### SUMMARY OF THE INVENTION

The present invention addresses the potential need to provide better ways of meeting visibility requirements of brake and turn signal lights on vehicles by a trailing vehicle. In particular, the present invention is directed to a vehicle light assembly that integrates active and passive illumination sources within a single substrate/platform. The disclosed light assembly comprises intermingled/interleaved/interspersed active and passive illumination source regions, yet the passive and active illumination sources utilize distinct surface areas upon the substrate/platform to provide illuminating light.

### BRIEF DESCRIPTION OF THE DRAWINGS

While the appended claims set forth the features of the present invention with particularity, the invention, together with its objects and advantages, may be best understood from the following detailed description taken in conjunction with the accompanying drawings of which:

FIG. 1a is a diagram depicting an exemplary layout of active and passive illumination elements interspersed on a common platform for a signal/light assembly;

FIG. 1b is a diagram depicting an exemplary positioning of a set of current limiting resistors on the underside of the common platform for the light assembly; and

FIG. 1c depicts a side view of the signal/light assembly.

### DETAILED DESCRIPTION OF THE DRAWINGS

The illustrative embodiments of the present invention disclosed herein are directed to a distinct way of providing both active and passive illumination via optical elements carried by a single platform/structure. In the disclosed embodiments, active illumination and passive illumination elements provide illumination from separate and distinct regions of the single platform/structure of an assembly. The separate and distinct nature of the passive and active illumination regions facilitates using two distinct colors for the differing types of illumination. In the exemplary embodiment, the active illumination elements are interspersed/interleaved with the passive illumination source(s). Furthermore, the passive illumination is provided by “retro reflective” material that, in contrast to a planar mirror, reflects light back at its source within a wide range of angles of incidence. The following description is based on embodiments of the invention and should not be taken as limiting the invention with regard to alternative embodiments that are not explicitly described herein.

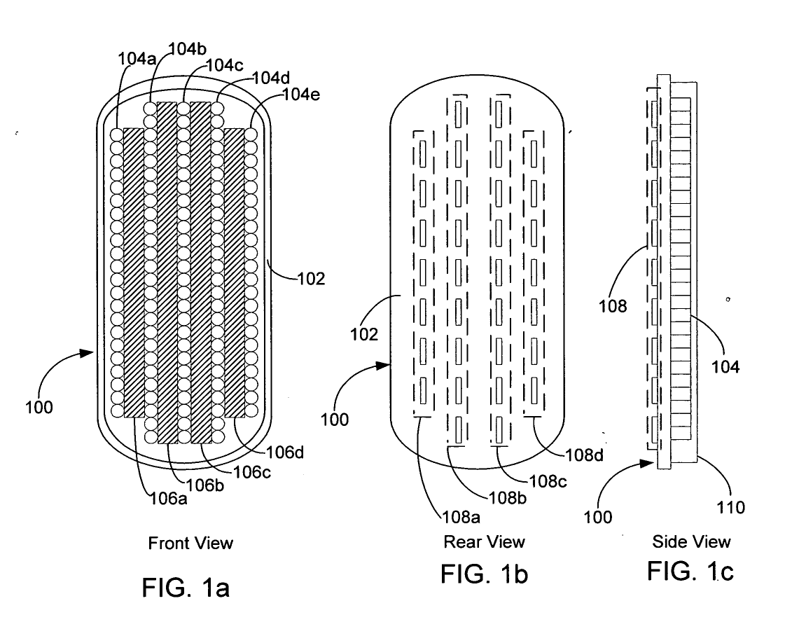

Turning now to the drawings, and in particular FIG. 1a, a diagram depicts an exemplary layout of active and passive illumination elements interspersed on a common platform for a signal/light assembly 100. In this exemplary embodiment, active illumination elements are interleaved with passive illumination elements on a platform 102. In an exemplary embodiment, the platform 102 is a printed circuit board including wiring (not shown) deposited thereon for circuits providing power to rows of active illumination elements 104a, 104b, 104c, 104d, and 104e. Alternatively, the wires connecting the active illumination elements 104a, 104b, 104c, 104d, and 104e to a power source are formed separately from the platform 102.

The platform 102 can be provided in any of a variety of shapes and dimensions. The illustrative example depicts an exemplary taillight assembly that is generally rectangular in shape, but also includes rounded corners, in yet other embodiments the platform is round, square, or virtually any desired shape. Furthermore, while the illumination surface of the exemplary platform 102 is flat, in alternative embodiments the illumination surface is non-planar (e.g., convex, concave, semi-cylindrical, etc.).

In the illustrative embodiment the active illumination elements 104a, 104b, 104c, 104d, and 104e comprise sets of individually encapsulated discrete LEDs. However, in alternative embodiments the active illumination portion of a signal/light assembly comprises sets of LEDs encapsulated within a single circuit package (potentially also including current-limiting resistors). In alternative embodiments the active illumination elements 104a, 104b, 104c, 104d, and 104e comprise other active illumination types including, for example, incandescent fluorescent light sources.

The color of the active illuminators 104 varies in accordance with various alternative embodiments of the invention. In addition to red and amber, any of a variety of light colors are emitted by the active illuminators 104. Furthermore, the light emitted by the active source is not limited to visible light. Rather, the active illumination elements 104a-e in various alternative embodiments emit light in non-visible energy ranges such as infrared and ultraviolet regions of the light spectrum.

In accordance with disclosed embodiments of the present invention, the active illumination elements 104a-e share a viewable surface area of the platform 102 with passive illumination sources 106a, 106b, 106c and 106d. The passive illumination sources 106a-d, in the illustrative embodiment are presented as, but not limited to, a set of rectangular regions interleaved with rows (linear arrays) of the active illumination elements 104a-e.

The dispersal pattern of active illumination elements on a viewable surface of the platform 102 that also provides surface area for the passive illumination sources 106a-d differs in accordance with alternative embodiments. However, in embodiments of the invention substantially homogenous dispersal patterns are utilized that enhance the viewable extent of both passive and active illumination on the light/signal assembly 100.

The material making up the passive illumination sources 106a-d varies in accordance with alternative embodiments of the invention. In an exemplary embodiment, the passive illumination sources 106a-d comprise retro reflective film that is laminated upon, or adhered to, the surface of the platform 102 by means of a pressure sensitive adhesive or any other suitable bonding method. Such reflective film (often silver in color) is currently used on traffic signs and warm up jackets. The film is non-conductive (or if conductive, spaced from electronic component leads) to ensure against short circuits between leads of the active illumination elements 106. The active illumination elements 104 are installed upon the surface of the platform 102 over the retro reflective film. The signal leads of the active illumination elements 104, by way of example, pass through the retro reflective film. The signal leads are connected to a power source circuit including limiting resistors that are attached, by way of example, to the bottom of the platform 102 (see FIG. 1b described herein below).

Alternatively, the passive illuminator 106 comprises a plastic molded retro reflective substrate commonly referred to as “reflex”. Such plastic material, often red in color, is incorporated into the external panels that cover turn signal and brake light assemblies of automobiles. In the illustrative embodiment set forth in FIG. 1a, the passive illuminator 106 comprises a set of plastic retro reflective rectangular blocks 106a-d mounted upon the platform 106. In other embodiments, apertures/channels formed in a structure comprising the passive illuminator 106 provide a path for light emitted by a set of the active illumination elements 104. In a particular variation of this embodiment, the plastic material comprising the retro reflective substrate also includes the platform 102 structure. In yet other embodiments, openings within the structure of the passive illuminator 106 act as sockets/guides for individual ones (e.g., LEDs) of the active illumination elements 104. As mentioned previously above, the active illuminators 104 and passive illuminator 106 are laid out in a substantially balanced and intermingled (interspersed/interleaved) manner over a surface area of the platform 102. Such complimentary distribution of passive and active illumination sources within a common perimeter enhances the overall conspicuity of the light/signal assembly.

Having described the viewable surface of exemplary light/signal assemblies, attention is directed to FIG. 1b that depicts an exemplary positioning scheme for a set of current limiting resistors on the underside of the common platform for the light assembly. In the illustrative embodiment, leads of LEDs depicted in FIG. 1a, pass through the platform 102 and are soldered in place on a rear side of the platform 102, a view of which is provided in FIG. 1b. In the illustrative embodiment, rows of current limiting resistors 108a, 108b, 108c and 108d are also soldered to the rear side of the platform 102. While not depicted in the drawing, each LED (or group of LEDs) is connected in series to one of the current limiting resistors within the rows of resistors 108a-d. The printed circuit on the rear face of the platform 102, in addition to providing electrical connections between the leads of the LEDs and corresponding current limiting resistors, connects the LEDs to a power supply. Though not depicted in FIG. 1b, a series of leads are, by way of example, terminated by a power and ground connection of an external connector—or any other suitable leads for facilitating connecting the light assembly to a power source.

Turning briefly to FIG. 1c, in an embodiment of the invention, the passive illuminator 106 and active illuminators 104 are protected from dirt and moisture by a cover 108 that forms a sealed compartment for the active illuminators 104 that is backed by the platform 102 of the light/signal assembly 100. In an embodiment of the invention, the cover 108 comprises a clear or substantially transparent material that allows light to pass through with little attenuation of desired wavelengths. As such, both the active and passive illuminators are clearly visible under appropriate circumstances.

The light/signal assembly 100 and alternative embodiments disclosed herein include complimentary, intermingled regions dedicated to active and passive illumination sources. The applications of such light/signal assembly are numerous. For example, a single assembly embodying the present invention incorporates both an active yellow turn indicator and a red retro reflector visible to other vehicles approaching from behind. Combining the active and passive illumination components in the manner disclosed herein potentially reduces labor and material costs associated with installing a light/signal assembly on the rear of a motor vehicle. Furthermore, the disclosed invention facilitates versatile vehicle styling as well as integrating larger numbers of lamp/signal functions (e.g., stop, tail, turn, reverse, clearance, parking) into a single assembly.

In view of the many possible embodiments to which the principles of this invention may be applied, it should be recognized that the embodiments described herein with respect to the drawing figures are meant to be illustrative only and should not be taken as limiting the scope of the invention. Therefore, the invention as described herein contemplates all such embodiments as may come within the scope of the following claims and equivalents thereof.

What is claimed is:

1. A light assembly including both active and passive illumination sources and having a viewable surface from which the active and passive illumination sources provide light, and wherein the viewable surface comprises:
a first part comprising the passive illumination source; and
a second part, distinct from the first part, comprising the active illumination source, wherein the first part and the second part are intermingled over the viewable surface.

2. The light assembly of claim 1 wherein the first and second parts of the viewable surface are arranged as a set of interleaved striped regions.

3. The light assembly of claim 1 wherein the active illumination source comprises LEDs.

4. The light assembly of claim 1 wherein the active illumination source comprises incandescent light sources.

5. The light assembly of claim 1 wherein the active illumination source comprises fluorescent light sources.

6. The light assembly of claim 1 wherein the passive illumination source comprises retro reflective film.

7. The light assembly of claim 1 wherein the passive illumination source comprises retro reflective molded plastic.

8. The light assembly of claim 1 further comprising a protective covering of the viewable surface.

9. The light assembly of claim 8 wherein the protective covering is substantially colorless.

10. The light assembly of claim 1 wherein the active and passive illumination sources discharge differing colors of light.

11. The light assembly of claim 1 wherein the active illumination source emits light in a non-visible range.

12. The light assembly of claim 111 wherein the active illumination source primarily emits light within an infrared range.
